(19) United States
(12) Patent Application Publication
(10) Pub. No.: US 2010/0300728 A1
(43) Pub. Date: Dec. 2, 2010

(54) NANOWIRES USING A CARBON NANOTUBE TEMPLATE

(76) Inventor: EZEKIEL KRUGLICK, Poway, CA (US)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/473,004

(22) Filed: May 27, 2009

(51) Int. Cl. H01B 5/00; B05D 5/12; B05D 1/04; B44C 1/22; C25D 13/12

(52) U.S. Cl. 174/126.1; 427/122; 427/475; 216/13; 204/479

(57) ABSTRACT

The present disclosure generally describes methods for forming nanowires on a substrate, where carbon nanotubes may be placed in a pattern on a surface of a substrate. The surface of the substrate may be exposed to conditions such that carbothermal reduction occurs between the carbon nanotubes and the substrate to form nanotrenches in the pattern, and a conductive material may be deposited into the nanotrenches for forming nanowires.

### BACKGROUND

Carbon nanotubes (CNTs) have been studied for many different applications due to their electrical and/or mechanical properties. CNTs are very small tube-shaped structures having the composition of a graphite sheet rolled into a tube. Carbon nanotubes have electrical conductance related to their structure, are chemically stable, and have very small diameters (less than 100 nanometers) and large aspect ratios (length/diameter).

Carbon nanotubes have already been shown to be useful for a variety of applications, for example, field emission devices (FEDs), nanoscale electromechanical actuators, field-effect transistors (FETs), electron guns, CNT based random access memory (RAM), microscopic electronics, atomic force microscope (AFM) probes, materials science, biology and chemistry. Carbon nanotubes may be formed using any of a variety of metal substrates and are well aligned, and may uniformly extend in a direction substantially perpendicular to the metal substrate, or parallel to the metal substrate.

Presently, there is great interest in the fabrication of functional semiconductor devices with length scales below 100 nm, i.e., nanoelectronics. The laws of physics allow, in theory, the building of logic devices such as transistors with characteristic length scales on the order of about 1 nm. Reaching these limits, however, has been difficult and expensive.

Methods for fabricating devices below 100 nm include both top down and bottom up approaches. Conventional top down approaches such as photolithography or electron beam lithography utilize formation and selective removal of various levels to form functional devices, which may be very expensive for devices with features below 100 nm.

### BRIEF DESCRIPTION OF THE FIGURES

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIGS. 1(a)-(d) are illustrations of a substrate formed by some example methods;

FIGS. 2(a)-(c) are illustrations of a substrate formed by some additional example methods;

FIG. 3 is a schematic illustration of a chemical vapor deposition (CVD) chamber;

FIGS. 4(a) and (b) are illustrations of carbon nanotube patterns that may be provided on a substrate;

FIG. 5 is a flow diagram illustrating some example methods of forming a substrate with nanowiring;

FIG. 6 is a flow diagram illustrating some additional examples methods of forming a substrate with nanowiring; and

FIG. 7 illustrates a block diagram of an example computer program product in accordance with the present disclosure, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the figures, may be arranged, substituted, combined, separated, and designed in a wide variety of different configurations, all of which are implicitly contemplated herein.

The figures include numbering to designate illustrative components of examples shown within the drawings, including the following: A substrate 10, carbon nanotubes 20, a surface 30 of the substrate 10, nanotrenches 40, a conductive material 50 a layer 60, a CVD chamber 70, an inlet 80 and an outlet 90. Steps 310-330 and steps 410-490 show illustrative steps of the examples in the figures.

Illustrative examples herein describe substrates having nanotrenches and methods of manufacturing such substrates. Many other examples may also be possible, but time and space limitations prevent including an exhaustive list of those examples in one document. Accordingly, other examples within the scope of the claims will become apparent to those skilled in the art from the teachings of this application.

Some examples may include substrates with nanotrenches for forming nanowires thereon. The substrates may then be used for a wide variety of applications in nanoelectronics or other fields, such as other chemical or biological applications.

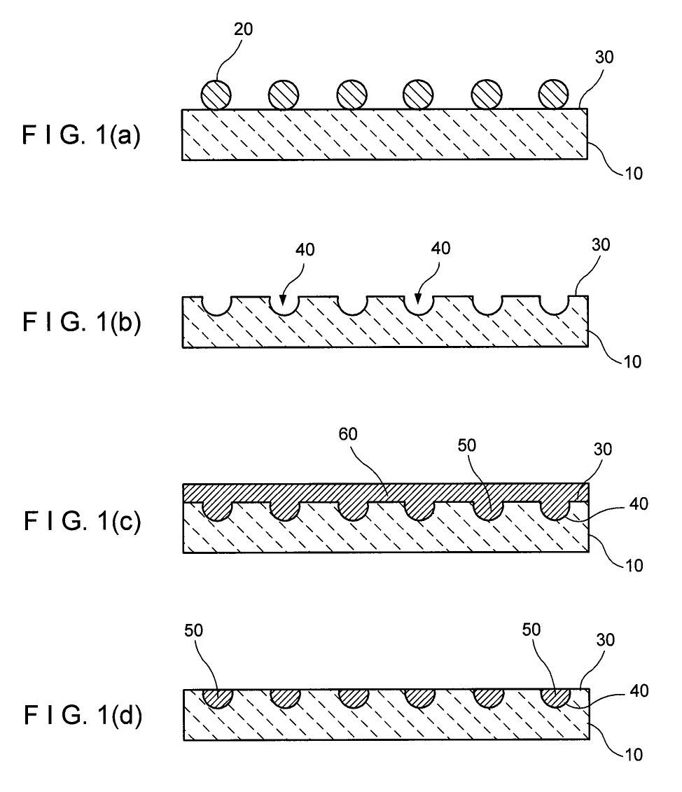

FIGS. 1(a)-(d) are illustrations of a substrate formed by some example methods that are arranged in accordance with the present disclosure. In FIG. 1(a), a substrate 10 is illustrated with carbon nanotubes 20 aligned on a surface 30 of the substrate 10. FIG. 1(b) shows the substrate 10 with nanotrenches 40 formed on the substrate after carbothermal reduction has occurred. FIG. 1(c) illustrates a layer 60 of a conducting material that may be deposited on top of the surface 30 of the substrate 10, forming conductive elements 50 in the nanotrenches 40. As shown in FIG. 1(d), the conductive material from layer 60 may be removed or cleaned off the substrate 10, leaving the conductive material so remaining in the nanotrenches 40. This forms a substrate 10 with a conductive material 50, e.g., copper, deposited in the nanotrenches 40.

Carbothermal etching may be performed for the carbothermal reduction to occur on the substrate 10 to form nanotrenches 40, as shown in FIG. 1(b). Carbon has been found to etch silicon dioxide (SiO₂) at high temperatures in a carbothermal reaction, as described in “Carbon nanotube guided formation of silicon oxide nanotrenches” by Hey Ryung Byon et al., Nature Publishing Group, Feb. 18, 2007, which is herein incorporated in its entirety by reference. Carbon nanotubes may act as the carbon source to reduce (etch) SiO₂ surfaces. By introducing small amounts of oxygen gas during the growth of single-walled carbon nanotubes in a chemical vapor deposition (CVD) process (i.e. processing in a temperature and pressure controlled CVD chamber), the nanotubes may selectively etch nanotrenches in the SiO₂. The substrate 10 may be exposed to a temperature and a pressure over a period of time sufficient for carbothermal reduction to occur. The time can vary depending on several factors, such as the temperature, pressure, size of the substrate, and other factors as would be appreciated by one of ordinary skill in the art.

The shape, length and trajectory of the nanotrenches may be fully determined by the pattern in which the carbon nanotubes are layered out on the SiO₂. The depth of the nanotrench made by the example noted may be, for example, between approximately 1 nm and approximately 10 nm measured from the adjacent or near surface of the substrate, and may in one example be approximately 4 nm deep.

The main driving force for nanotrench formation is carbothermal reduction of SiO₂ in illustrative examples. The parenthetical “(s)” below is used to indicate a solid state or phase, and the parenthetical “(g)” is used to indicate a gaseous state or phase in this example. In this process, carbon nanotubes play the role of bulk carbon (C(s)). Amorphous bulk silica (SiO₂(s)) may be reduced by carbon at temperatures approximately over 1,754° C. and under atmospheric pressure by releasing SiO(g) and CO(g), as shown below:

SiO₂(s)+C(s) [symbol] SiO(g)+CO(g)

After carbothermal reduction has reduced the carbon nanotubes 20 into nanotrenches 40 on the surface 30 of the substrate 10, as shown in FIG. 1(b), the substrate may be removed from the CVD chamber in one example, and a conductive material 50 may be deposited into the nanotrenches 40 for forming nanowires in the pattern of the nanotrenches 40 on the substrate 10. The conductive material 50 may be any materials or metal suitable and a nanowiring conductor and for depositing in the nanotrenches. The conductive material 50 is deposited into the nanotrenches, as shown in FIG. 1(c), for example, using a supercritical carbon dioxide (CO₂) metal deposition process, which may deposit metal into nanometer sized cavities. This may be performed by a supercritical process chamber.

Supercritical CO₂, as referred to above, may refer to carbon dioxide that is in a fluid state while also being at or above both its critical temperature and pressure, yielding particular properties. CO₂ usually behaves as a gas in air at standard temperature and pressure (STP) or as a solid such as dry ice when frozen. If the temperature and pressure are both increased from STP to be at or above the critical point for CO₂, it may adopt properties midway between a gas and a liquid. More specifically, the CO₂ behaves as a supercritical fluid above its critical temperature (31.1° C.) and critical pressure (72.9 atm), expanding to fill its container like a gas but with a density like that of a liquid.

In the supercritical state, CO₂ has a molecular number density as high as that of liquids and diffusivity as high as that of gases. Supercritical CO₂ may thus penetrate deep into small features and deliver copper precursors with a high mass flux. Conversion of the precursors to metallic copper in the supercritical CO₂ may realize copper filling in high aspect ratio small features at a high deposition rate. This meets the requirements not only for further downscaling to nano size but also for the fabrication of inter chip conductors of 3-D integrated circuits where deci micron deep features are involved. Thus, supercritical CO₂ metal deposition may be used in the examples described herein for forming nanowires in the nanotrenches formed in the substrate.

As shown in FIG. 1(c), supercritical CO₂ metal deposition may be used to deposit a conductive material 50 into the nanotrenches 40, and may also be used to create a layer 60 made of the same material as the conductive material 50 on top of the surface 30 of the substrate 10. In an example of this process, the metal may be deposited using supercritical CO₂ metal deposition as described in “Paving the way for Full-Fluid IC Metallization using Supercritical Carbon Dioxide” by E. Kondoh et al., 2003, which is incorporated in its entirety herein by reference. In this example, CO₂, a metal precursor, and H₂, if needed, may be introduced into a high-pressure reactor (supercritical machine). H₂ may be used to improve the quality of the metal, which may involve the appearance of a metallic, shiny, copper color, the formation of a continuous film structure, an increase in deposition yield, and/or good experimental reproducibility. Liquid CO₂ may then be pumped using a plunger pump to attain a pressure above the critical point of CO₂, and deposited into nano-sized cavities.

After the supercritical CO₂ metal deposition, the substrate 10 may then be removed from the supercritical machine and as shown in FIG. 1(d), the metal layer 60 may be removed or cleaned off the substrate 10, leaving the conductive material so remaining in the nanotrenches 40. This forms a substrate 10 with a conductive material 50, e.g., copper, deposited in the nanotrenches 40. The metal layer 60 may be removed by timed etching, chemical-mechanical polishing or a damascene process. The substrate 10 with its pattern of nanowires may now be used for various nanowiring applications, having a conductive material for conducting along the nanotrenches 40 of the substrate 10. The resultant pattern of nanowires in some examples is such that nanowires do not cross or conductively connect with each other over all or desired portions of the substrate. In other examples, the pattern may be random or involves many electrical contacts between nanowires. In some examples, the resulting nanowires may not extend above, or may not extend significantly above the top of the nanotrench. Some portions of the patterns may be aligned or parallel, while other portions of the pattern may be random or pseudo-random. Also, in another example, the pattern may be provided over only one or more portions of the substrate but not the entire surface or for the entire extent of the nanotrenches and the nanowires.

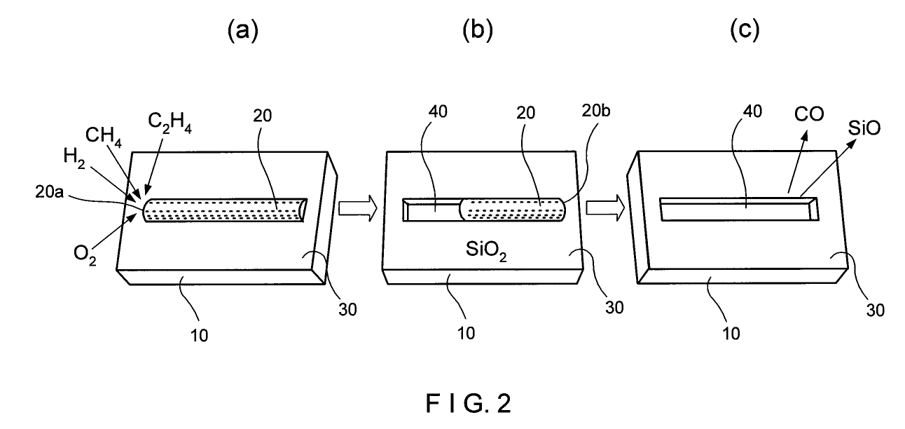

FIGS. 2(a)-(c) are illustrations of a substrate formed by some additional example methods in accordance with the present disclosure. In FIG. 2(a), an example in which a single carbon nanotube 20 is provided on a surface 30 of a substrate 10 is shown. The substrate 10 may be placed inside a CVD chamber, and the surface 30 of the substrate 10 may be exposed to a carbothermal etching fluid at a first end(s) 20a of the carbon nanotube(s) 20 inside the CVD chamber. The carbothermal etching fluid may be selected based on its chemical properties, and may comprise one or more gases, such as an oxygen gas (e.g., O₂), a hydrogen gas (e.g., H₂), methane (CH₄) and ethylene (C₂H₄), and may enter the CVD chamber at an inlet. The fluid may enter the CVD chamber through various different methods and mechanisms, as would be appreciated in light of the present disclosure.

Because both the solid-phase SiO₂ and carbon should be in contact with one another to enable the carbothermal reduction to occur, where the carbon nanotubes that make direct contact with the SiO₂ surface are active for the reaction. As shown in FIG. 2(b), the first end 20a of the carbon nanotube 20 is etched during the process when the first end 20a is exposed to the carbothermal reduction fluid, forming the nanotrench 40. In FIG. 2(b), incomplete reaction between the carbon nanotube 20 and the SiO₂ left a portion of the carbon nanotube 20 unreacted at the second end 20b of the nanotrenches. In FIG. 2(c), the carbothermal reduction has occurred and etched the entire carbon nanotube 20, forming a nanotrench 40 in the substrate 10. Additional hydrocarbons in the gas may help increase the volume of SiO₂ removed.

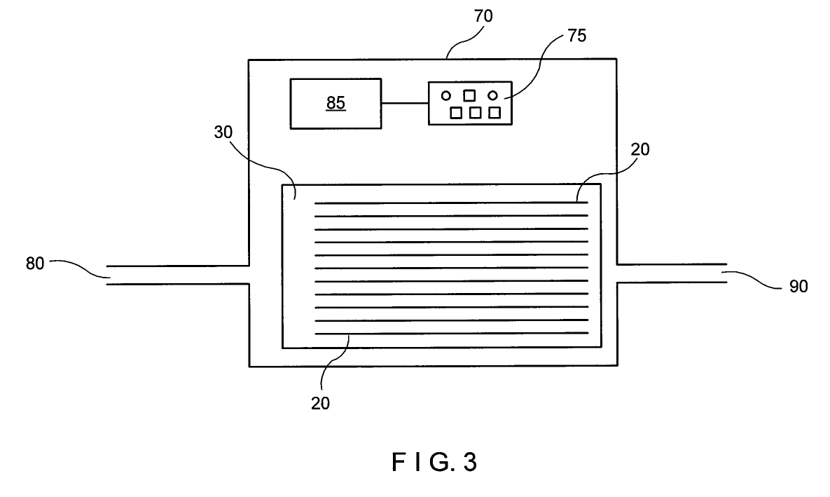

FIG. 3 is a schematic illustration of a chemical vapor deposition (CVD) chamber arranged in accordance with the present disclosure. The carbothermal etching (or carbothermal reduction) described previously above may be conducted in a chemical vapor deposition (CVD) chamber 70, in which multiple carbon nanotubes 20 on a surface 30 of a substrate 10 are placed inside a CVD chamber at a predetermined temperature and pressure.

The flow of gases into and out of the CVD chamber 70 including the control of the pressure of the CVD chamber 70 may be facilitated by various valves 75 that may be controlled by a controller 85. For example, fluids and/or gases may enter the CVD chamber 70 at one or more inlets (e.g., inlet 80), whiles gases and/or fluids may exit the CVD chamber 70 at one or more (e.g., outlet 90). The temperature and pressure of the CVD chamber 70 may also be controlled by the controller 85, such as by controlling valves 75 which can comprise a temperature/pressure adjustment, or the temperature and pressure may be controlled by a computer controlled process through the controller 85. The controller 85 may also control other variables, such as the time of exposure, the flow of materials such as gases and fluids through the inlet 80 and outlet 90, and other various process controls.

The carbothermal etching fluid, which may contain one or more gases may enter the CVD chamber 70 at inlet 80. The carbon monoxide (CO) and silicon oxide (SiO) gases from the reaction may be removed from the CVD chamber 70 from the outlet 90, as shown in FIG. 3. Fluid may enter or exit the CVD chamber 70 through various different methods and mechanisms, as would be appreciated in light of the present disclosure.

Although some or all of the SiO(g) and CO(g) may be vented out through outlet 90 under the steady flow of gases during the reaction, it is possible that most of the SiO(g) and CO(g) may be reabsorbed on the top edges of the nanotrenches, so that they further react, by themselves or with incoming fragmentized hydrocarbon and oxygen gases, to form shoulder lines along both sides of the nanotrenches, standing above the nanotrenches. Since taller shoulders are found around deeper and wider nanotrenches, it is anticipated that the origin of a shoulder may be closely related to the amounts and chemical identities of the reduced species of SiO₂, that is, SiO(g) and CO(g).

Including small amounts of oxygen may trigger the destruction of carbon nanotubes, generating locally confined reactive carbonaceous species that readily react with the SiO₂ at the same temperature. The efficiency of nanotrench formation may be directly affected by the levels of oxygen and hydrocarbon gases. While it has been found that nanotrenches may form with an oxygen concentration lower than ˜0.01% of total gases, when applying the process under certain conditions, such as using atmosphere pressure. A very high yield of nanotrenches has been obtained with 0.1% of added oxygen; above this oxygen level no reaction is normally attempted because of safety issues, although it is envisioned that such a process may be possible. Hydrocarbon gases may be supplied to further accelerate the reduction of the SiO₂ surface via the carbothermal reaction. When the average volume of the nanotrenches formed and the stoichiometric reaction between SiO₂ and C are considered, the amount of carbon provided just by the carbon nanotubes using an average diameter of approximately 1.7 nm, has been found to be insufficient to etch out the entire underlying SiO₂ layer to form the nanotrenches. But additional etching of SiO₂ may occur by means of externally supplied fragmentized hydrocarbons.

Although the temperature is preferably over 1,754° C., in some examples, the temperature provided for the carbothermal reaction in some examples is not uniform and may be provided, for example, by a rapid thermal anneal (RTA), short-duration source to avoid overheating the bulk of the material and disturbing any circuits that may have already been fabricated on the substrate 10.

The substrate 10 may be a silicon substrate with a SiO₂ surface 30. Alternatively, the substrate may be made of other materials with suitable properties such as germanium oxide and indium phosphide.

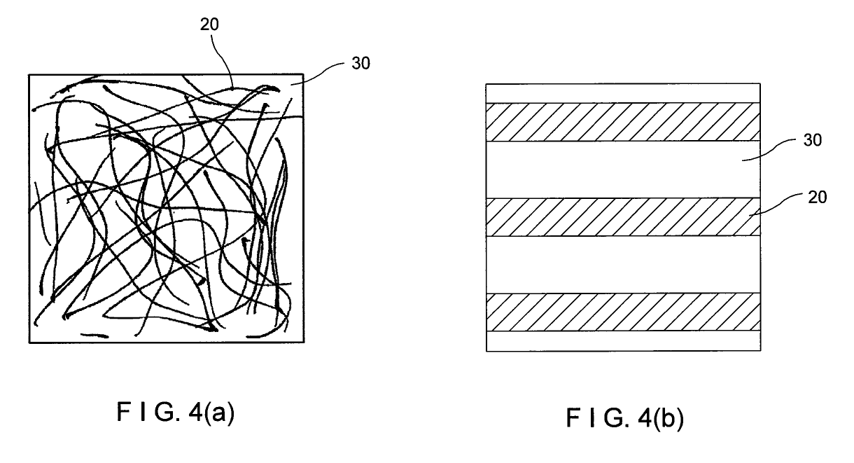

FIGS. 4(a) and (b) are illustrations of carbon nanotube patterns that may be provided on a substrate, in accordance with at least some embodiments of the present disclosure. As illustrated in FIG. 4(a), the carbon nanotubes 20 may be arranged in a pattern such as a random-mat format on the surface of the substrate. As illustrated in FIG. 4(b), the carbon nanotubes 20 may be arranged in a pattern where the carbon nanotubes 20 may be aligned in a substantially parallel manner with respect to each other. In most examples, the pattern may be such that most of the nanotubes do not cross or touch each other to enable forming of independent nanowires at least over substantive portions of the substrate. The carbon nanotubes 20 may be electro-sprayed on the surface of the substrate, grown in place, or provided by another method. The carbon nanotubes 20 may be aligned in a substantially parallel manner by suitable methods, such as by an external electric field as described in “Aligning single-wall carbon nanotubes with an alternating-current electric field” by X. Q. Chen et al., in Applied Physics Letters, Volume 78, Number 23, Jun. 4, 2001, which is herein incorporated in its entirety by reference. Single-wall carbon nanotubes (SWCNTs) may be aligned to a high degree of accuracy. The alignment of SWCNTs shows significant dependencies on the frequency and the magnitude of the applied electric field. An electric field with 5 MHz may improve the alignment of the SWCNTs and may create highly oriented samples. The aligning may be performed by other processes such as polymer stretching, templating or electrophoresis.

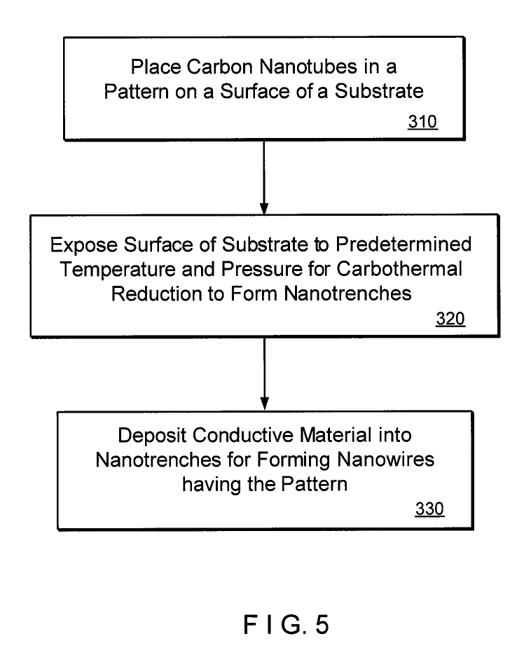

FIG. 5 is a flow diagram illustrating some example methods of forming a substrate with nanowiring in accordance with at least some embodiments of the present disclosure. Initially, carbon nanotubes 20 may be placed in a pattern on a surface of the substrate 10 in block 310 in accordance with the description above. The substrate 10 may then be exposed to a predetermined temperature and pressure at block 320, for carbothermal reduction to occur to form nanotrenches on the surface of the substrate. The conductive material 50 may then be deposited into the nanotrenches for forming nanowires having the pattern on the substrate at block 330.

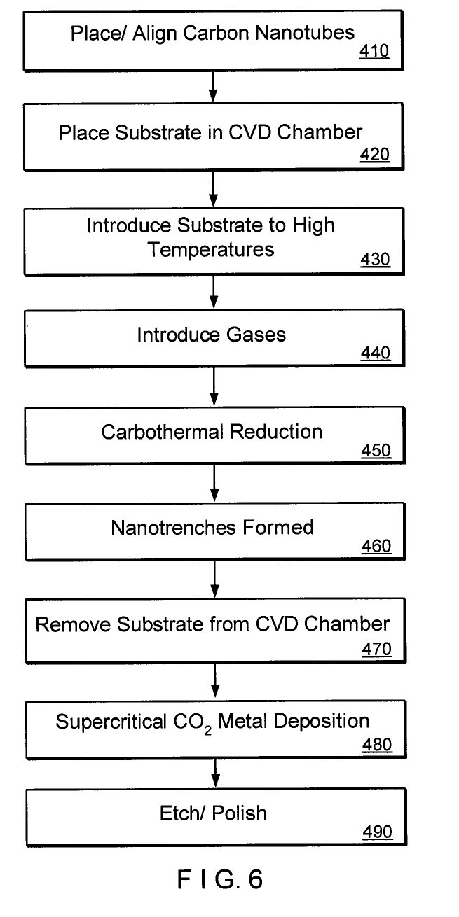

FIG. 6 is a flow diagram illustrating some additional example methods of forming a substrate with nanowiring in accordance with at least some embodiments of the present disclosure. Initially, at block 410, carbon nanotubes 20 may be placed, formed and/or aligned on the substrate 10 in accordance with the description above. The substrate 10 may then be placed inside a CVD chamber at block 420, and then may be exposed to high temperatures at block 430, e.g., over 1754° C. where the substrate is SiO₂. At block 440, gases may be introduced inside the CVD chamber, to help with the carbothermal reduction, such as O₂, H₂, CH₄ and C₂H₄. At block 450, carbothermal reduction of the carbon nanotubes 20 on the surface of the substrate 10 may occur.

The substrate 10 may then be removed from the CVD chamber at block 470, and metal may be deposited into the nanotrenches 40 using supercritical CO₂ metal deposition at block 480. This may be performed in a supercritical machine, as previously described above. After the metal has been deposited on the surface of the substrate to form a conductive material, the metal layer on the surface of the substrate may be etched/polished at block 490 so that the conductive material may be deposited within the nanotrenches 40, as shown and described previously with reference to FIG. 1(d).

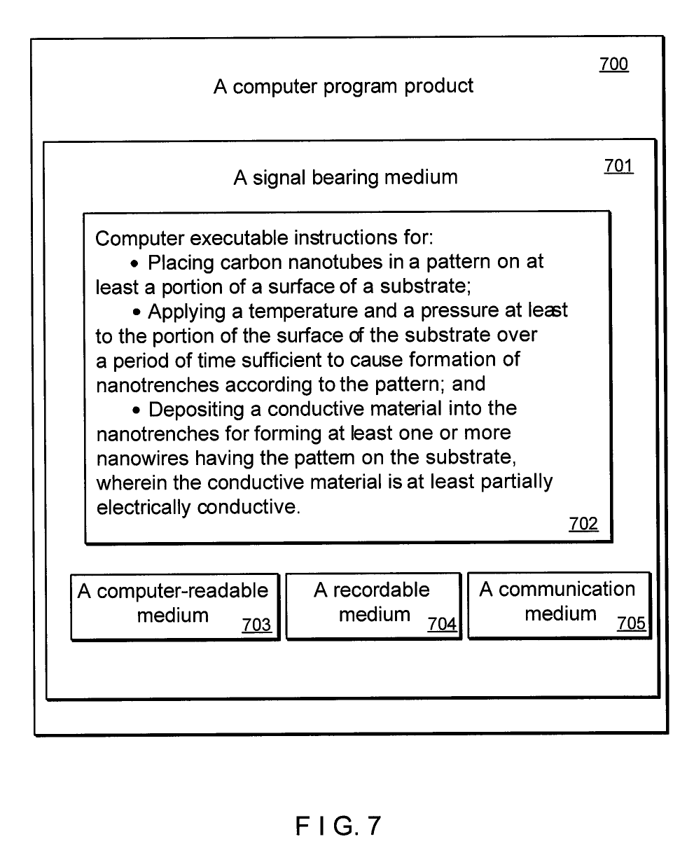

FIG. 7 illustrates a block diagram of an example computer program product in accordance with the present disclosure. In some examples, a computer program product 700 includes a signal bearing medium 701 that may also include computer executable instructions 702. Computer executable instructions 702 may be arranged to provide instructions for forming nanowires on a substrate. Such instructions may include, for example, instructions relating to placing carbon nanotubes in a pattern on at least a portion of a surface of a substrate. Such instructions further may include, for example, instructions relating to applying a temperature and a pressure at least to the portion of the surface of the substrate over a period of time sufficient to cause formation of nanotrenches according to the pattern. Such instructions further may include, for example, instructions relating to depositing a conductive material into the nanotrenches for forming at least one or more nanowires having the pattern on the substrate, wherein the conductive material is at least partially electrically conductive. Generally, the computer executable instructions 702 may include instructions for performing any steps of the method for forming nanowires on a substrate described herein.

Also depicted in FIG. 7, in some examples, computer product 700 may include one or more of a computer readable medium 703, a recordable medium 704 and a communications medium 705. The dotted boxes around these elements may depict different types of mediums that may be included within, but not limited to, signal bearing medium 701. These types of mediums may distribute programming instructions 702 to be executed by computer devices including processors, logic and/or other facility for executing such instructions. Computer readable medium 703 and recordable medium 704 may include, but are not limited to, a flexible disk, a hard disk drive (HDD), a Compact Disc (CD), a Digital Video Disk (DVD), a digital tape, a computer memory, etc. Communication medium 705 may include, but is not limited to, a digital and/or an analog communication medium (e.g., a fiber optic cable, a waveguide, a wired communication link, a wireless communication link, etc.).

As shown above, combined with placement/alignment techniques for carbon nanotubes, well-ordered nanotrenches of a depth of 1-10 nm may be formed to produce nanowires for various high-density electronic components in the nanoelectronics industry. Nanowires have lower electrical parasitics and higher packing densities than existing wire approaches. Nanowires are a highly desirable functional component for connecting circuits in integrated circuits, a multi-billion dollar industry, and may also be used for biological applications, such as for sensors used within tissue.

The various aspects, features or implementations of examples of the present disclosure described herein may be used alone or in various combinations. The method examples of the present disclosure may be implemented by software, hardware or a combination of hardware and software (e.g., software stored on a computer-accessible medium).

The present disclosure is not to be limited in terms of the particular examples described in this application, which are intended as illustrations of various aspects. Many modifications and examples may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular devices, methods, systems, which can, of course, vary. It is also to be understood that the terminology used herein is for the purpose of describing particular examples only, and is not intended to be limiting.

The foregoing describes various examples of substrates used for nanowiring and methods for forming nanowires on a substrate. Following are specific examples of methods and substrates thereof. These are for illustration only and are not intended to be limiting. The present disclosure generally relates to a method for forming a substrate for nanowiring.

Provided and described herein, for example, is a method for forming nanowires on a substrate, including the steps of placing carbon nanotubes in a pattern on at least a portion of a surface of a substrate, applying a temperature and a pressure at least to the portion of the surface of the substrate over a period of time sufficient to cause formation of nanotrenches according to the pattern; and depositing a conductive material into the nanotrenches for forming nanowires having the pattern on the substrate, wherein the conductive material is at least partially electrically conductive.

Further, the surface of the substrate may comprise SiO₂. The conductive material may comprise a metal. The nanotrenches may have a depth from the surface of the substrate in an inclusive range from approximately 1 m to approximately 10 nm. The predetermined temperature may be approximately over 1754° C. The predetermined pressure may be approximately 1 atm.

The placing of the carbon nanotrenches may comprise aligning the carbon nanotubes so that at least a portion of the carbon nanotubes are substantially parallel to each other. The aligning of the carbon nanotubes may comprise one of polymer stretching, templating, electrophoresis or applied electric fields.

The method may further comprise exposing the surface of the substrate to a fluid when applying the temperature and the pressure. The fluid may comprise a gas having oxygen gas, hydrogen gas, methane and/or ethylene. The depositing of the conductive material may comprise applying a supercritical CO₂ metal deposition process. The method may further comprise cleaning the conductive material by one of a timed etching process, a chemical-mechanical polishing process or a damascene process.

Also provided and described herein, for example, is a method for forming nanowires on a substrate, comprising the steps of placing carbon nanotubes in a pattern on at least a portion of a surface of a substrate, wherein at least a portion of the carbon nanotubes on the surface of the substrate are substantially aligned with respect to each other, applying a temperature and a pressure at least to the portion of the surface of the substrate over a period of time sufficient to etch nanotrenches in the pattern; and depositing a metal on the substrate such that nanotrenches are filled with the deposited metal and such that a layer of the deposited metal is formed about the surface of the substrate, and etching at least a portion of the layer of the metal from the surface of the substrate so that metal remains in the nanotrenches of the substrate to form nanowires, wherein at least a portion of the nanowires are substantially aligned according to a pattern of the nanotrenches of the substrate.

Also provided and described herein, for example, is an electrically conducting structure, comprising a substrate defining a pattern of nanotrenches having a depth in a range of approximately 1 nm to approximately 10 nm from a surface of the substrate, and a conductive material disposed inside the nanotrenches, wherein the conductive material is electrically conductive.

The substrate may comprise a SiO₂ material defining the nanotrenches. The conductive material may comprise one or more of a conductor, a semiconductor, or a metal. The nanotrenches may have a depth of approximately 4 nanometers relative to the surface of the substrate. The nanotrenches may be formed by carbothermal reduction and the conductive material may be formed by supercritical CO₂ metal deposition. The nanotrenches may be formed in a random pattern. The pattern may include a portion in which the nanotrenches are aligned to minimize or reduce contact between the conductive material in each of the nanotrenches.

Also provided and described herein, for example, is a computer-readable medium comprising computer readable instructions which are provided for forming nanowires on a substrate wherein, when a processing arrangement executes the instructions, the processing arrangement is configured for placing carbon nanotubes in a pattern on at least a portion of a surface of a substrate, applying a temperature and a pressure at least to the portion of the surface of the substrate over a period of time sufficient to cause formation of nanotrenches according to the pattern, and depositing a conductive material into the nanotrenches for forming at least one or more nanowires having the pattern on the substrate, wherein the conductive material is at least partially electrically conductive.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like include the number recited and refer to ranges which may be subsequently broken down into subranges as discussed above. Finally, as will be understood by one skilled in the art, a range includes each individual member.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. A method for forming nanowires on a substrate, the method comprising:
placing carbon nanotubes in a pattern on at least a portion of a surface of a substrate;
applying a temperature and a pressure at least to the portion of the surface of the substrate over a period of time sufficient to cause formation of nanotrenches according to the pattern; and
depositing a conductive material into the nanotrenches for forming at least one or more nanowires having the pattern on the substrate, wherein the conductive material is at least partially electrically conductive.

2. The method of claim 1, wherein the surface of the substrate comprises silicon dioxide.

3. The method of claim 1, wherein the conductive material comprises a metal.

4. The method of claim 1, wherein the nanotrenches have a depth from the surface of the substrate in an inclusive range from approximately 1 nm to approximately 10 nm.

5. The method of claim 1, wherein the predetermined temperature is approximately over 1754° C.

6. The method of claim 1, wherein the predetermined pressure is approximately 1 atm.

7. The method of claim 1, wherein placing carbon nanotrenches comprises aligning the carbon nanotubes so that at least a portion of the carbon nanotubes are substantially parallel to each other.

8. The method of claim 7, wherein aligning the carbon nanotubes comprises one of polymer stretching, templating, electrophoresis or applied electric fields.

9. The method of claim 1, further comprising exposing the surface of the substrate to a fluid when applying the temperature and the pressure.

10. The method of claim 9, wherein the fluid comprises a gas having oxygen gas, hydrogen gas, methane and/or ethylene.

11. The method for claim 1, wherein depositing the conductive material comprises applying a supercritical carbon dioxide metal deposition process.

12. The method of claim 1, further comprising cleaning the conductive material by one of a timed etching process, a chemical-mechanical polishing process, or a damascene process.

13. A method for forming nanowires on a substrate, comprising:
placing carbon nanotubes in a pattern on at least a portion of a surface of a substrate, wherein at least a portion of the carbon nanotubes on the surface of the substrate are substantially aligned with respect to each other;
applying a temperature and a pressure at least to the portion of the surface of the substrate over a period of time sufficient to etch nanotrenches in the pattern;
depositing a metal on the substrate such that the nanotrenches are filled with the deposited metal and such that a layer of the deposited metal is formed about the surface of the substrate; and
etching at least a portion of the layer of the metal from the surface of the substrate so that metal remains in the nanotrenches of the substrate to form nanowires, wherein at least a portion of the nanowires are substantially aligned according to a pattern of the nanotrenches of the substrate.

14. An electrically conducting structure, comprising:
a substrate defining a pattern of nanotrenches having a depth in a range of approximately 1 nm to approximately 10 nm from a surface of the substrate; and
a conductive material disposed inside the nanotrenches, wherein the conductive material is electrically conductive.

15. The electrically conducting structure of claim 14, wherein the substrate comprises a silicon dioxide material defining the nanotrenches.

16. The electrically conducting structure of claim 14, the conductive material comprising one or more of a conductor, a semiconductor, or a metal.

17. The electrically conducting structure of claim 14, wherein the nanotrenches are formed by carbothermal reduction and the conductive material is formed by supercritical carbon dioxide metal deposition.

18. The electrically conducting structure of claim 14, wherein the nanotrenches are formed in a random pattern.

19. The electrically conducting structure of claim 14, wherein the pattern includes a portion in which the nanotrenches are aligned to minimize or reduce contact between the conductive material in each of the nanotrenches.

20. A computer-readable medium comprising computer readable instructions which are provided for forming nanowires on a substrate wherein, when a processing arrangement executes the instructions, the processing arrangement is configured for:
placing carbon nanotubes in a pattern on at least a portion of a surface of a substrate;
applying a temperature and a pressure at least to the portion of the surface of the substrate over a period of time sufficient to cause formation of nanotrenches according to the pattern; and
depositing a conductive material into the nanotrenches for forming at least one or more nanowires having the pattern on the substrate, wherein the conductive material is at least partially electrically conductive.
